(19) United States
(12) Patent Application Publication
(10) Pub. No.: US 2023/0262821 A1
(43) Pub. Date: Aug. 17, 2023

(54) METHOD AND APPARATUS FOR MANAGEMENT OF UNSTRUCTURED PDU SESSION TYPES

(71) Applicant: Samsung Electronics Co., Ltd., Suwon-si (KR)

(72) Inventor: Mahmoud WATFA, Staines (GB)

(21) Appl. No.: 18/041,121

(22) PCT Filed: Aug. 11, 2021
(86) PCT No.: PCT/KR2021/010639

§ 371 Date: Feb. 9, 2023

(30) Foreign Application Priority Data
Aug. 11, 2020 (GB) 2012503.5

(51) Int. Cl. H04W 76/20; H04W 28/02; H04W 76/30

(52) U.S. Cl. CPC H04W 76/20; H04W 28/0268; H04W 76/30

(57) ABSTRACT

A method for managing a Protocol Data Unit, PDU, session at a terminal in a mobile communications network, the method comprising: receiving, from the mobile communications network, a PDU session management message associated with a PDU session; determining, based on a type of the PDU session, whether the PDU session management message includes an operation related to an invalid PDU session parameter, and if the PDU session management message includes an operation related to an invalid PDU session parameter, rejecting the PDU session management message, releasing the PDU session, or modifying the PDU session.

### CROSS-REFERENCE TO RELATED APPLICATIONS

This application is a 371 of International Application No. PCT/KR2021/010639 filed on Aug. 11, 2021, which claims priority to United Kingdom Patent Application No. 2012503.5 filed on Aug. 11, 2020, the disclosures of which are herein incorporated by reference in their entirety.

### BACKGROUND

### 1. Field

The present disclosure relates to method and apparatus for the management of unstructured PDU session types.

### 2. Description of Related Art

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 giga-Hertz (GHz) bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as technologies connectivity network where humans generate and consume information, is now evolving to the Internet of things (IoT) where the cloud server has IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

### SUMMARY

The present disclosure provides method and apparatus for the management of unstructured PDU session types.

### BRIEF DESCRIPTION OF THE DRAWINGS

Examples of the present disclosure are further described hereinafter with reference to the accompanying drawings, in which:

FIG. 1 provides an flow diagram illustrating an approach for detecting invalid PDU sessions parameters or invalid PDU session operations at a UE; and

FIG. 2 provides a schematic diagram of a UE in accordance with an example of the present disclosure.

FIG. 3 illustrates a base station according to embodiments of the present disclosure.

### DETAILED DESCRIPTION

It is an aim of certain examples of the present disclosure to provide approaches for managing unstructured PDU sessions types in 3rd Generation Partnership Project 5th Generation Systems (3GPP 5GS). However, references to particular 3GPP constructs in certain examples should not be understood as limiting the ability of examples of the present disclosure to be applied to other wireless communication networks.

According to a first aspect of the present disclosure there is provided a method for managing a Protocol Data Unit, PDU, session at a terminal in a mobile communications network The method comprises receiving, from the mobile communications network, a PDU session management message associated with a PDU session; determining, based on a type of the PDU session, whether the PDU session management message includes an operation related to an invalid PDU session parameter, and if the PDU session management message includes an operation related to an invalid PDU session parameter, rejecting the PDU session management message, releasing the PDU session, or modifying the PDU session.

In an example of the present disclosure, determining whether the PDU session management message includes an operation related to an invalid PDU session parameter includes: determining whether the PDU management message is associated with an unstructured PDU session, and determining whether the PDU management message includes an operation related to a PDU session parameter that is invalid for an unstructured PDU session.

In another example of the present disclosure, determining whether the PDU session management message includes an operation related to an invalid PDU session parameter further includes determining whether the PDU session management message is an initial request or a request for modifying an existing PDU session.

In another example of the present disclosure, operations related to invalid PDU session parameters for an unstructured PDU session include any of: a request for creating or modifying a non-default Quality of Service, QoS, rule; a request for creating or modifying a QoS flow description that does not correspond to a default QoS rule of the PDU session; a request for creating or modifying a mapped Evolved Packet System, EPS, bearer that does not correspond to a default QoS rule of the PDU session; a request for creating a default QoS rule with a non-zero number of packet filters, or a request for modifying a packet filter associated with a QoS rule.

In another example of the present disclosure, an operation for creating or modifying a default QoS rule that does not include a packet filter relates to a valid PDU session parameter for an unstructured PDU session.

In another example of the present disclosure, modifying the PDU session includes deleting, at the terminal, an invalid PDU session parameter resulting from the operation related to an invalid PDU session parameter.

In another example of the present disclosure, modifying the PDU session includes transmitting to the mobile communications network a request for modifying an invalid PDU session parameter resulting from the operation related to an invalid PDU session parameter.

In another example of the present disclosure, the request for modifying an invalid PDU session parameter includes a request for deletion of the invalid PDU session parameter.

In another example of the present disclosure, releasing the PDU session includes transmitting to the mobile communications network a request for release of the PDU session.

In another example of the present disclosure, a request for creating a default QoS rule with a zero number of packet filters (i.e. an empty packet filter list) relates to a valid PDU session parameter for an unstructured PDU session.

In another example of the present disclosure, the PDU management message is for establishing a new PDU session or a request for modifying an existing PDU session.

In another example of the present disclosure, if the PDU session management message includes an operation related to an invalid PDU session parameter, the method further includes transmitting to the mobile communications network an indication or a cause value that the PDU session includes an invalid PDU session parameter.

In another example of the present disclosure, the session management message is associated with an unstructured PDU session.

*24 In another example of the present disclosure, the mobile communications network is a 3GPP 5G communications system.

According to a second aspect of the present disclosure there is provided a terminal for managing Protocol Data Unit, PDU, sessions in a mobile communications network. The terminal comprises a controller, and a transceiver, wherein the controller in conjunction with the transceiver is configured to receive, from the mobile communications network, a PDU session management message associated with a PDU session; determine, based on a type of the PDU session, whether the PDU session management message includes an operation related to an invalid PDU session parameter, and if the PDU session management message includes an operation related to an invalid PDU session parameter, reject the PDU session management message, release the PDU session, or modify the PDU session.

According to an example of the present disclosure, the controller in conjunction with the transceiver is configured to perform any of the above methods.

According to another aspect of the present disclosure there is provided a computer readable storage medium having stored thereon computer executable instructions which when executed by a computer cause the computer to perform any of the above methods.

Wireless or mobile (cellular) communications networks in which a terminal, such as a mobile handset or user equipment (UE) communicates via a radio link with a network of base stations, or other wireless access points or nodes, have undergone rapid development through a number of generations. The 3rd Generation Partnership Project (3GPP) design, specify and standardise technologies for mobile wireless communication networks. Fifth Generation (5G) systems are now being deployed.

5G systems support different types of data transfer via Protocol Data Unit (PDU) sessions. Each PDU session has a PDU session type that indicates which type of data the session is being used for. 5G systems support the following PDU session types: IPv4, IPv6, IPv4v6, Unstructured, Ethernet, and these are defined in section 9.11.4.11 in TS 24.501. Among these PDU session types, unstructured PDU sessions may support different configurations to PDU sessions of the other types, and therefore there is a requirement for approaches for effectively managing unstructured PDU sessions.

Herein, the following documents are referenced:
[1] 3GPP TS 24.501 V16.5.1
[2] 3GPP TS 23.501 V16.3.0
[3] 3GPP TS 24.301 V16.5.1

In 5G systems one or more Quality of Service (QoS) rules may be associated with or included in a PDU session, where a QoS rule and a QoS rules information element (IE) that may be received by a User Equipment (UE) are defined in section 9.11.4.13 of [1]. QoS flow descriptions associated with a QoS rule and the contents of a QoS flow descriptions IE are also set out in [1]. The QoS rules and QoS flow description may be set or modified at the UE via the establishment or modification of a PDU session, for example, via a PDU Session Establishment Accept message or a PDU Session Modification Command message received from the network, where these messages are defined in [1]. The UE may also make requests to the network for the establishment, modification, and release of a PDU session.

There are restrictions on the configurations of PDU sessions, where these restrictions relate to parameters/characteristics of a PDU session. Consequently, Non-Access Stratum (NAS) specifications set out in [1] require that a UE verifies parameters and/or operations associated with the contents of QoS rules and QoS flow descriptions (i.e. the contents of the QoS rules and flow descriptions IE) for various types of errors during the PDU session establishment procedure and during a PDU session modification procedure.

Among PDU QoS characteristics, a QoS rule may be a default QoS rule or a non-default QoS rule, where a QoS rule is determined to be a default based on a Default QoS Rule (DQR) bit included in the QoS, where a QoS rule is a default QoS rule if the DQR bit is set to “the QoS rule is the default QoS rule”, and is not a default QoS rule if the bit is set to “the QoS rule is not the default QoS rule”. One example of a restriction on the configuration of PDU sessions is that a PDU session cannot contain more than one default QoS rule. As such a UE should verify that such case does not occur. If it does, the UE considers this an error, and should take appropriate steps to rectify the error.

Section 6.4.1.3 of [1] sets out errors that should be detected during a PDU session establishment procedure and during a PDU session modification procedure. For example, among other things, the following is specified in relation to the operations/parameters included in a QoS Rules IE and a QoS Flow Descriptions IE that may be included in the messages for PDU session establishment and modification.
a) Semantic errors in QoS operations:

When the rule operation is “Create new QoS rule”, and the DQR bit is set to “the QoS rule is the default QoS rule” when there's already a default QoS rule.

When the rule operation is “Create new QoS rule”, and there is no rule with the DQR bit set to “the QoS rule is the default QoS rule”.

When the rule operation is “Create new QoS rule” and two or more QoS rules associated with this PDU session would have identical precedence values.

When the rule operation is an operation other than “Create new QoS rule”, and the request type is “initial request” or “initial emergency request”.

When the rule operation is “Create new QoS rule”, the DQR bit is set to “the QoS rule is not the default QoS rule”, the request type is “initial request” and the UE is in NB-N1 mode.

When the rule operation is “Create new QoS rule” and two or more QoS rules associated with this PDU session would have identical QoS rule identifier values.

When the flow description operation is an operation other than “Create new QoS flow description”, and the request type is “initial request” or “initial emergency request”.

When the flow description operation is “Create new QoS flow description”, the request type is “initial request”, the QFI associated with the QoS flow description is not the same as the QFI of the default QoS rule and the UE is NB-N1 mode.

In case 4 and case 5, if the rule operation is for a non-default QoS rule, the UE shall send a PDU SESSION MODIFICATION REQUEST message to delete the QoS rule with 5GSM cause #83 “semantic error in the QoS operation”.

In case 7 and case 8, the UE shall send a PDU SESSION MODIFICATION REQUEST message to delete the QoS flow description with 5GSM cause #83 “semantic error in the QoS operation”.

Otherwise for all the cases above, the UE shall initiate a PDU session release procedure by sending a PDU SESSION RELEASE REQUEST message with 5GSM cause #83 “semantic error in the QoS operation”.

As shown above in relation to 1), when the UE detects that there is another (i.e. more than one) default QoS rule that is being created, the UE releases the PDU session by sending the PDU Session Release Request message in which it includes the 5GSM cause #83. It should be noted that since a PDU session may be subject to inter-working with EPS, the UE also verifies for other types of errors that are related to EPS QoS parameters as specified in [1]. The full set of error checks that the UE performs during the PDU session establishment request can be found in section 6.4.1.3 in [1] and the set of error checks that the UE performs during PDU session modification can be in section 6.3.2.4 in [1].

It is specified in [1] and [2] that PDU sessions of types IPv4, IPv6, IPv4v6, and Ethernet may include a non-default QoS rule but an a PDU session for Unstructured PDU session type (i.e. an unstructured PDU session) may only include a default QoS rule. Furthermore, an unstructured PDU session should not contain a packet filter (PF). Further details on the requirements and characteristics of unstructured PDU sessions is set out in section 5.7.1.5 of [2]. However, the current approach to verifying PDU session parameters or identifying operations related to invalid PDU session parameters may not correctly identify parameters/operations that are invalid when a PDU is of an unstructured type, thus leading to invalid parameters/operations not being detected, and valid parameters/operations being wrongly determined to be invalid by the UE.

The differences in valid parameters between unstructured PDU sessions types and one or more of the other PDU session types in combination with the current approaches to verifying PDU session parameters or identifying operations related to invalid PDU session parameters may lead to at least the following problems when verifying configurations/parameters/operations for unstructured PDU sessions.

1) An unstructured PDU session type can only have one QoS rule and that must be the default QoS rule. As such, there may be errors in which the network attempts to create a non-default QoS rule for an unstructured PDU session. If this happens, there are currently no means for the UE to detect this and hence the UE may end up having non-default QoS rules that are not permitted or supported by such a PDU session.

2) There cannot be any Packet Filters (PFs) for an unstructured PDU session. Currently, the UE does not verify if a default QoS rule includes any PFs, and, if this the case (i.e. the default QoS rule includes a PF), then there may be erroneous handling of uplink packets for an unstructured PDU session.

3) UEs currently verify if there is a QoS rule for which the rule operation is “Create new QoS rule” and the PF list in the QoS rule is empty, since it is not currently permitted to have an empty PF list for a QoS rule (i.e. it is not permitted to have zero PFs). If a PF list is empty, it is specified in [1] that “if the QoS rule is the default QoS rule, the UE shall initiate a PDU session release procedure by sending a PDU SESSION RELEASE REQUEST message with 5GSM cause #84 “syntactical error in the QoS operation””. This means that a default QoS rule with the operation “Create new QoS rule” can never have an empty PF set and if this occurs then the UE should consider this it as an error. However, this current behaviour contradicts the requirement for a PDU session of Unstructured data type for which no PF should be available.

Consequently, there is a need for approaches for detecting operations and/or parameters related to these invalid/erroneous configurations for unstructured PDU sessions and also preventing valid configurations being wrongly identified as invalid for unstructured PDU sessions.

### Verification of Parameters for Unstructured PDU Sessions

Parameters of a PDU session at a UE may be set via the receipt of Non-Access Stratum (NAS) PDU session management message such as a PDU Session Establishment Accept message or a PDU Session Modification Command message for example. Approaches for identifying invalid PDU operations and parameters resulting from each the receipt of each type of message are described separately, however, each of the techniques may be applied to identifying invalid/erroneous PDU parameters resulting from either type of message. Furthermore, any combination of the various approaches may be implemented together with one another, and more than one invalid PDU parameter may be detected from a single PDU session management message. Similarly, more than once invalid parameter may be determined (i.e. detected) by a single technique.

In the examples described below, the verification of PDU sessions parameters or operations related to a PDU session is said to be performed on the content of a PDU management message, such as a PDU establishment or modification messages (i.e. based on the content of the various information elements of the messages), but the examples are not only limited to this. The verification (i.e. detection of invalid parameters or operations) may take place during the setting of PDU session parameters that is being performed in response to receipt of an establishment or modification message, or after the parameters of the PDU session have been set based on the receipt of an establishment or modification message. Although invalid parameters/operations are predominantly referred, the terms erroneous, unsupported, prohibited may also be used. Furthermore, although verification has been referred to here, the process of identifying invalid PDU parameters may also be referred to as detecting and determining the presence of invalid erroneous PDU session parameters. Lastly, although the detection of invalid parameters is predominantly referred to, PDU session configurations, operations related to a PDU session, operations related to PDU parameters, and PDU sessions characteristics may also be referred to.

The action taken by a UE to rectify, address or handle any invalid PDU parameters once detected may take place at various stages, and also in various manners depending on, among other things, the type of PDU management message. For example, rectification action may comprise one or more of releasing the PDU session, transmitting a request for modification of the PDU session to the network, local deletion/amendment of parameters that are invalid, ignoring the operation related to the invalid PDU parameter, and transmitting indication of an error in a PDU configuration the network. Consequently, although rectification action may be described as occurring at a particular stage for the various invalid parameters, they are not only limited to this. Further details on the various possible rectification actions are set out below with respect each type of invalid parameter/operation and each type of PDU session management message.

It is presumed that the functionality relating to the detecting of the invalid parameters related to unstructured PDU sessions is implemented as a default setting at the UE, however, this functionality may be optionally implemented. For example, part of or all of the disclosed error detection processes may be performed only when requested or configured by the network or when preconfigured in the UE.

Lastly, in the examples set out below, one or more alternative checking orders are given but the techniques are not limited to these, since the pertinent issue is the combination of conditions (e.g. unstructured PDU session and creation of a non-default QoS rule) rather than the order in which the conditions are detected. However, it should be noted that some orderings may provide a more efficient approach to the detection of invalid parameters/operations than others.

### Verification During PDU Session Establishment Procedure

### Default QoS Rule

As set above, an unstructured PDU session should only include a default QoS rule and therefore instances where a PDU session either includes more than one default QoS rule or an operation that relates to an unstructured PDU session includes an operation related to a non-default QoS rule should be detected, and optionally, appropriate rectifying action taken.

In accordance with a first example, if a PDU session is unstructured (i.e. the request is for establishing an unstructured PDU session) and optionally if the request type is “initial request” (e.g. a request for a new PDU session), the UE checks if any of the QoS rules received contains an operation set to “Create new QoS rule” where the DQR bit is set to “the QoS rule is not the default QoS rule” (i.e. there is an operation to create a new QoS rule that is not a default QoS rule). If there is an operation to create a new QoS rule that is not a default QoS rule, the UE detects an error due to the invalidity of such an operation/parameter for an unstructured PDU session.

Alternatively, when the rule operation is “Create new QoS rule”, the DQR bit is set to “the QoS rule is not the default QoS rule”, the PDU session type is unstructured, and the request type is “initial request”, the UE detects an error due to the invalidity of such an operation/parameter for an unstructured PDU session.

If an invalid parameter is detected, the UE may, after the completion of the current PDU session establishment procedure, send a PDU Session Modification Request message (including a requested QoS rules IE) to delete each QoS rule that is not the default QoS rule. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE may initiate the PDU session release procedure by sending a PDU Session Release Request message to the network. In this case the UE can include any of the existing 5GSM causes e.g. 5GSM cause #83 “semantic error in the QoS operation”, or #84 “syntactical error in the QoS operation”, etc. Anew 5GSM cause may also be defined and used for this purpose. The new 5GSM cause can be any value that is specific to this error or generic to cover multiple types of errors.

Alternatively, the UE does not indicate an error to the network or request session release or modification, and locally deletes each QoS rule is not the default QoS rule. In this case, the UE may optionally indicate the erroneous PDU parameters to the network.

### QoS Flow Description

As set out in 9.11.4.13 of [1], each QoS rule has an associated QoS flow identifier (QFI), where parameters of a PDU session (i.e. those included in IEs other than the QoS rules IE) may associated with a QoS rule by virtue of a QFI. Consequently, in addition to detecting non-default QoS rules, PDU session parameters for an unstructured PDU sessions that have a QFI that does not correspond to a default QoS rule should be detected. One such parameter a QoS flow descriptions.

In accordance with another example, if the PDU session is unstructured and optionally if the request type is “initial request”, the UE checks if the flow description operation (in the Authorized QoS flow descriptions) is set to “Create new QoS flow description”, and the QFI of the QoS flow description is not the same as the QFI that is associated with default QoS rule. If the QFI is not the same as the QFI of the default QoS rule, the UE detects an error due to the invalidity of such an operation/parameter for an unstructured PDU session.

Alternatively, when the flow description operation is “Create new QoS flow description”, the request type is “initial request”, the QFI associated with the QoS flow description is not the same as the QFI of the default QoS rule, and the PDU session type unstructured, the UE detects an error due to the invalidity of such an operation/parameter for an unstructured PDU session.

If an invalid parameter or operation is detected, the UE may, after the completion of the current PDU session establishment procedure, send a PDU Session Modification Request message (including a Requested QoS flow descriptions IE) to delete each QoS flow description that has a QFI which is not the same as the QFI of the default QoS rule. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE may initiate a PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and shall locally delete each QoS flow description that has a QFI which is not the same as the QFI of the default QoS rule. In this case, the UE may optionally indicate the erroneous PDU parameters to the network.

### Mapped EPS Bearer

A request for establishment of a PDU session may also include Mapped EPS bearer contexts IE which sets of various parameters related to an EPS bearer mapped to a PDU session, where the EPS bearer may be associated with a specific QoS rule via a QFI.

Consequently, in accordance with another example, if the PDU session is unstructured the UE should check if there is at least one mapped EPS bearer operation (in the Mapped EPS bearer contexts IE if received) with the operation code set to “Create new EPS bearer” and the QFI corresponds to a QoS rule that is not the default QoS rule. If the QFI is not the same as the QFI of the default QoS rule, the UE detects an error due to the invalidity of such an operation/parameter for an unstructured PDU session.

Alternatively, the UE checks if there is at least one mapped EPS bearer operation (in the Mapped EPS bearer contexts IE if received) with the operation code set to “Modify existing EPS bearer” and the associated QoS flow identifier (QFI) corresponds to a QoS rule that is not the default QoS rule and if the PDU session is unstructured, the UE detects an error due to the invalidity of such an operation/parameter for an unstructured PDU session.

If an invalid parameter or operation is detected, the UE may, after the completion of the current PDU session establishment procedure, send a PDU Session Modification Request message (including the Mapped EPS bearer contexts IE) to delete each mapped EPS bearer context with a QFI that is not the same as the QFI of the default QoS rule. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE shall initiate the PDU session release procedure by sending the PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and locally deletes each mapped EPS bearer context with a QFI that is not the same as the QFI of the default QoS rule.

### Non-Zero Packet Filters

As set out above, unstructured PDU sessions should not include a packet filter and therefore PDU session parameters or operations that relate to a QoS rule that includes a packet filter or otherwise attempts to modify packet filter parameters, should be detected.

Consequently, in another example, if a PDU session is unstructured and optionally if the request type is “initial request”, the UE checks if any of the QoS rule received contains an operation set to “Create new QoS rule” and optionally the DQR bit is set to “the QoS rule is the default QoS rule” (i.e. there is an operation to create a new QoS rule that is a default QoS rule). For such a rule the UE should additionally verify if there is a packet filter list that is not empty (e.g. the UE may verify if the ‘Number of packet filters’ field in the QoS rule is non-zero). If the number of packet filters field is non-zero, the UE detects an error due to the invalidity of such an operation/parameter for an unstructured PDU session.

Alternatively, the above can be achieved by the UE first checking whether a rule operation is “Create new QoS rule”, whether the DQR bit is set to “the QoS rule is the default QoS rule”. If these conditions are fulfilled, the UE may check whether the PDU is unstructured, and whether the PF list in the QoS rule is not empty. If the number of packet filters field is non-zero, the UE detects an error due to the invalidity of such an operation/parameter for an unstructured PDU session.

If an invalid parameter or operation is detected the UE may, after the completion of the current PDU session establishment procedure, send a PDU Session Modification Request message (including the Requested QoS rules IE) to delete each QoS rule (optionally the rule being a non-default QoS rule) for which there is a non-empty packet filter list.

Alternatively, if the QoS rule in question is the default QoS rule, the UE should not delete the QoS rule but rather the UE may, optionally after the completion of the current PDU session establishment procedure, send a PDU Session Modification Request message (including a Requested QoS rule IE) to delete all the packet filters of the default QoS rule. In this case the UE can include any of the existing 5GSM causes e.g. 5GSM cause #83 “semantic error in the QoS operation”, or #84 “syntactical error in the QoS operation”, etc.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and locally deletes each packet filter that is received, or that is associated with, the default QoS rule. In this case, the UE may optionally indicate the erroneous PDU parameters to the network.

### Zero Packet Filters

With respect to problem 3), the UE should consider an empty packet filter list for a rule operation that is set to “Create new QoS rule” as an error only if the PDU session type is not unstructured (i.e. it is IPv4, IPv6, or IPv4v6 or Ethernet). In other words, the presence of an empty packet filter list should not be detected as an error when it is in relation to a default QoS rule for an unstructured PDU sessions. However, current approaches do not permit this and would therefore lead to a false detection of an invalid PDU session parameter.

In accordance with an example, if a PDU session type is unstructured and optionally if the request type is “initial request”, if any of the QoS rules received contain an operation set to “Create new QoS rule” and optionally the DQR bit is set to “the QoS rule is the default QoS rule” and the packet filter list is empty, then this is not be considered to be an error by the UE since it is a valid operation/parameter for an unstructured PDU session.

If the PDU session type of the PDU session is not “Unstructured”, or the PDU session type is other than “Unstructured” (i.e. for a PDU session of type IP (IPv4, IPv6, or IPv4v6) or Ethernet), and optionally if the request type is “initial request”, if the operation set to “Create new QoS rule” and optionally the DQR bit is set to “the QoS rule is the default QoS rule” and optionally the packet filter list is empty, then the UE should consider this to be an error.

Alternatively, the above can be achieved by the UE checking whether the rule operation is “Create new QoS rule”, the PDU session type is other than unstructured, and the packet filter list in the QoS rule is empty. If these conditions are satisfied, then the UE should consider this to be an error since such a configuration is not valid for the types of PDU session other than unstructured.

If an invalid parameter or operation is detected, the UE may, after the completion of the current PDU session establishment procedure, send a PDU Session Modification Request message (including a requested QoS rule IE) to delete each QoS rule for which there is an empty packet filter list.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and shall locally delete each QoS rule that is determined to be erroneous (i.e. for which the packet filter set is empty). In this case, the UE may optionally indicate the erroneous PDU parameters to the network.

The proposals above have been described with respect to PDU session management message that arise when a UE is operating in the N1 mode. However, the proposals above also apply when the UE is in S1 mode for which the UE is proposed to verify the same errors on TFTs (Traffic Flow Templates), QoS rules and QoS flow descriptions during any ESM procedure. When similar errors are detected, the UE can send a corresponding NAS message to the MME and indicate any existing ESM cause or any new ESM cause that can be defined for this purpose (or a generic purpose).

### Verification During PDU Session Modification Procedure

### Non-Default QoS Rule

As set above, an unstructured PDU session should only include a default QoS rule and therefore instances where a PDU modification request relates to an unstructured PDU session and includes an operation related to a non-default QoS rule should be detected, and optionally, appropriate rectifying action taken. Consequently, errors may be detected as follows when a request for modification of an unstructured PDU session is received.

When the modification request includes an operation “Create new QoS rule” and the DQR bit is set to “the QoS rule is not the default QoS rule”, the UE detects an error.

When the modification request includes an operation “Modify existing QoS rule and add packet filters”, or “Modify existing QoS rule and replace all packet filters”, or “Modify existing QoS rule and delete packet filters” or “Modify existing QoS rule without modifying packet filters”, and optionally the operation is on a non-default QoS rule (i.e. for a QoS rule for which the DQR bit is set to “the QoS rule is not the default QoS rule”), the UE detects an error.

Alternatively, when the rule operation is “Modify existing QoS rule and add packet filters” or “Modify existing QoS rule and replace all packet filters” and the DQR bit is set to “the QoS rule is the default QoS rule”, the UE detects an error.

When the modification request includes an operation “Modify existing QoS rule and add packet filters”, or “Modify existing QoS rule and replace all packet filters”, or “Modify existing QoS rule and delete packet filters” or “Modify existing QoS rule without modifying packet filters”, and optionally the operation is on the default QoS rule (i.e. for which the DQR bit is set to “the QoS rule is the default QoS rule”), the UE detects an error.

Alternatively, when the rule operation is different to “Delete existing QoS rule”, and optionally the DQR bit of the QoS rule is set to “the QoS rule is not the default QoS rule”, the UE detects an error.

Alternatively, when the rule operation is different to “Modify existing QoS rule without modifying packet filters”, and optionally the DQR bit of the QoS rule is set to “the QoS rule is the default QoS rule”, the UE detects an error.

If an invalid parameter or operation is detected, the UE may, after the completion of the current PDU session modification procedure, send a PDU Session Modification Request message (including a requested QoS rules IE) to delete each of the QoS rule that is not the default QoS rule if any is detected. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE may initiate the PDU session release procedure by sending the PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE may reject the PDU modification request by transmitting a PDU SESSION MODIFICATION COMMAND REJECT message, optionally with an existing 5GSM cause code or a newly defined 5GSM cause code.

Alternatively, the UE does not indicate an error to the network or request session release or modification, and locally deletes each QoS rule is not the default QoS rule. In this case, the UE may optionally indicate the erroneous PDU parameters to the network.

### QoS Flow Description

For unstructured PDU sessions, the UE should also verify the Authorized QoS flow descriptions IE in a PDU Session Modification Command message and ensure that there is no QoS flow description that is associated with a non-default QoS rule and hence the only QoS flow description that is associated with a QoS rule should be the QoS flow description that is associated with the default QoS rule. Therefore, the UE should check if the QFI of the QoS flow description is the same as the QFI of the default QoS rule or not. If not, i.e. if the QFI of the QoS flow description is not the same as the QFI of the default QoS rule, then this should be considered as an error. Consequently, errors may be detected as follows when a request for modification of an unstructured PDU session is received.

If the modification request includes “Create new QoS flow description” for which the QoS flow identifier is not associated with the QFI of the default QoS rule, the UE detects an error.

If the modification request includes “Modify existing QoS flow description” for which the QoS flow identifier is not associated with the QFI of the default QoS rule, the UE detects an error.

If the flow description operation is different to “Delete existing QoS flow description” for which the QFI is not associated with the QFI of the default QoS rule (i.e. the QFI is not the same as the QFI of the default QoS rule), the UE detects an error.

If an invalid parameter or operation is detected, the UE may, after the completion of the current PDU session modification procedure, send a PDU Session Modification Request message (including a Requested QoS flow descriptions IE) to delete each QoS flow description that has a QFI which is not the same as the QFI of the default QoS rule. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may be defined and used for this purpose. The new 5GSM cause can be any value that is specific to this error or generic to cover multiple types of errors.

Alternatively, the UE does not indicate an error to the network or request session release or modification, and locally deletes each QoS flow description that has a QFI which is not the same as the QFI of the default QoS rule. In this case, the UE may optionally indicate the erroneous PDU parameters to the network.

Alternatively, the UE may reject the PDU modification request by transmitting a PDU SESSION MODIFICATION COMMAND REJECT message, optionally with an existing 5GSM cause code or a newly defined 5GSM cause code.

### Mapped EPS Bearer

For unstructured PDU sessions, the UE should also verify operations related to mapped EPS bearers in order to detect erroneous PDU parameters and/or operations. In particular, a UE should check if there is at least one mapped EPS bearer operation (in the Mapped EPS bearer contexts IE if received) whose QFI is not the same as the QFI of the default QoS rule. If not, i.e. if the QFI of the EPS operation is not the same as the QFI of the default QoS rule, then this should be considered as an error. Consequently, errors may be detected as follows when a request for modification of an unstructured PDU session is received.

If the modification request includes “Create new EPS bearer” and the associated QFI corresponds to a QoS rule that is not the default QoS rule, the UE detects an error.

If the modification request includes “Modify existing EPS bearer” and the associated QFI corresponds to a QoS rule that is not the default QoS rule, the UE detects an error.

Alternatively, if the mapped EPS bearer operation is different to “Delete existing EPS bearer” and the associated QFI corresponds to a QoS rule that is not the default QoS rule, the UE detects an error.

If an invalid parameter or operation is detected, the UE may, after the completion of the current PDU session modification procedure, send a PDU Session Modification Request message (including the Mapped EPS bearer contexts IE) to delete each mapped EPS bearer context with a QFI that is not the same as the QFI of the default QoS rule. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and shall locally delete each mapped EPS bearer context with a QFI that is not the same as the QFI of the default QoS rule.

Alternatively, the UE may reject the PDU modification request by transmitting a PDU SESSION MODIFICATION COMMAND REJECT message, optionally with an existing 5GSM cause code or a newly defined 5GSM cause code.

### Non-Zero Packet Filters

For unstructured PDU sessions, the UE may additionally detect other errors that are associated with the PDU Session Modification Command message. In particular, since an unstructured a PDU session only contain a default QoS rule, and the packet filter set should be empty, the UE should check the PDU Session Modification Command message to ensure that there can us only one QoS rule, and that should be the default QoS rule, and additionally that this rule should not contain any packet filter (set). Consequently, errors may be detected as follows when a request for modification of an unstructured PDU session is received.

If the modification request includes “Modify existing QoS rule and add packet filters”, or “Modify existing QoS rule and replace all packet filters”, or “Modify existing QoS rule and delete packet filters”, and optionally the operation is on a default QoS rule (i.e. for a QoS rule for which the DQR bit is set to “the QoS rule is the default QoS rule”), the UE detects an error.

If an invalid parameter or operation is detected, the UE may, after the completion of the current PDU session modification procedure, send a PDU Session Modification Request message (including the Requested QoS rules IE) to delete each QoS rule (optionally the rule being a non-default QoS rule) for which there is a non-empty packet filter list.

Alternatively, if the QoS rule in question is the default QoS rule, the UE may not delete the QoS rule but rather the UE should, optionally after the completion of the current PDU session establishment procedure, send a PDU Session Modification Request message (including a Requested QoS rule IE) to delete all the packet filters of the default QoS rule. In this case the UE can include any of the existing 5GSM causes e.g. 5GSM cause #83 “semantic error in the QoS operation”, or #84 “syntactical error in the QoS operation”, etc.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE does not indicate an error to the network or request session release or modification, and locally deletes each packet filter that is received, or that is associated with, the default QoS rule.

Alternatively, the UE may reject the PDU modification request by transmitting a PDU SESSION MODIFICATION COMMAND REJECT message, optionally with an existing 5GSM cause code or a newly defined 5GSM cause code.

### Zero Packet Filters

With respect to problem 3), the UE should consider an empty packet filter list for a rule operation that is set to “Create new QoS rule” as an error only if the PDU session type is not unstructured (i.e. it is IPv4, IPv6, or IPv4v6 or Ethernet). In other words, the presence of an empty packet filter list should not be detected as an error when it is in relation to a default QoS rule for an unstructured PDU sessions. However, current approaches do not permit this and would therefore lead to a false detection of an invalid PDU session parameter.

Consequently, in accordance with an example, when the rule operation is “Create new QoS rule”, “Modify existing QoS rule and add packet filters”, “Modify existing QoS rule and replace all packet filters” or “Modify existing QoS rule and delete packet filters”, the PDU session type is unstructured, and the packet filter list in the QoS rule is empty, then this is not be considered to be an error by the UE since it is a valid operation/parameter for an unstructured PDU session.

When the rule operation is “Create new QoS rule”, “Modify existing QoS rule and add packet filters”, “Modify existing QoS rule and replace all packet filters” or “Modify existing QoS rule and delete packet filters”, the PDU session type is different/other than unstructured, and the packet filter list in the QoS rule is empty, then the UE should consider this to be an error.

If the UE detects an error as described above, the UE may, after the completion of the current PDU session establishment procedure, send a PDU Session Modification Request message to delete each QoS rule (optionally a non-default QoS rule) for which there is an empty packet filter list. In this case the UE can include any of the existing 5GSM causes e.g. 5GSM cause #83 “semantic error in the QoS operation”, or #84 “syntactical error in the QoS operation”, etc.

Alternatively, the UE shall initiate the PDU session release procedure by sending a PDU Session Release Request message. In this case the UE can include any of the existing 5GSM causes e.g. 5GSM cause #83 “semantic error in the QoS operation”, or #84 “syntactical error in the QoS operation”, etc. A new 5GSM cause may also be defined and used for this purpose. The new 5GSM cause can be any value that is specific to this error or generic to cover multiple types of errors.

Alternatively, the UE may reject the PDU modification request by transmitting a PDU SESSION MODIFICATION COMMAND REJECT message, optionally with an existing 5GSM cause code or a newly defined 5GSM cause code.

Alternatively, the UE does not indicate an error to the network or request session release or modification, and locally deletes each QoS rule that is determined to be erroneous (i.e. for which the packet filter set is empty).

The approaches above also apply when the UE is in EPS (i.e. in S1 mode) and the PDN connection (with the equivalent PDN connection type) is transferable to N1 mode. As such, the UE should check for the same errors when the UE in S1 mode receives any of the existing ESM messages that are defined in TS 3GPP 24.301 [4]. For example, the UE should check for the same errors listed above in the QoS rules that are received in the Protocol configuration options IE or Extended protocol configuration options IE in the MODIFY EPS BEARER CONTEXT REQUEST message or in the ACTIVATE DEFAULT EPS BEARER CONTEXT REQUEST message or in the ACTIVATE DEDICATED EPS BEARER CONTEXT REQUEST message (where the latter is the ESM NAS message that is received in S1 mode). Similarly, an existing 5GSM cause can be used when sending an ESM message by the UE (e.g. the MODIFY EPS BEARER CONTEXT ACCEPT message) to report an error as described in section 6.1.4.1 of [2].

As such all the proposals above can apply when the UE is in either N1 mode or S1 mode. Note that in S1 mode, the equivalent of an Unstructured PDU session type is a PDN connection of type Non-IP (i.e. the PDN type is “non-IP”).

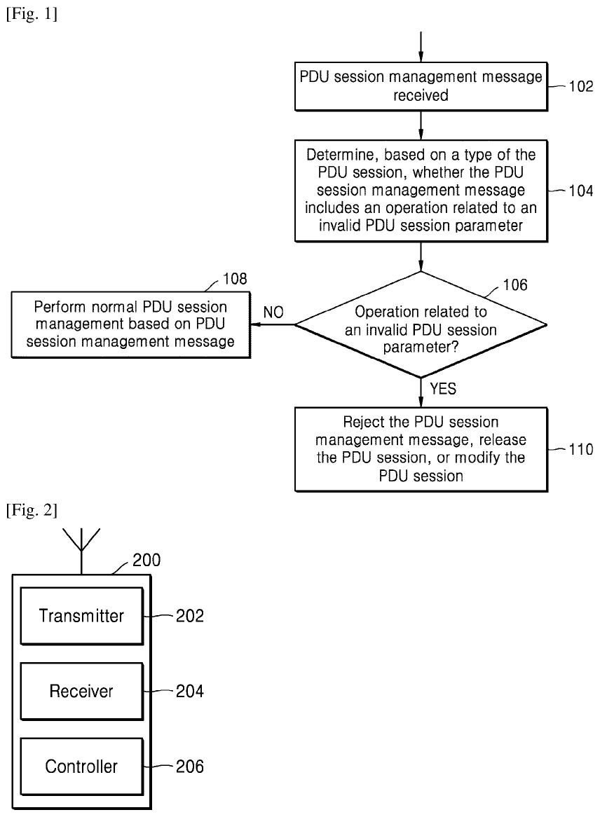

FIG. 1 provides flow diagram illustrating an example approach to the detection and rectification of invalid PDU sessions parameters or operations related to invalid PDU sessions parameters, where any combination of the checks/error detection may be used in step 104. However, although up to this point the detection and rectification of invalid PDU sessions parameters or operations relates to invalid PDU sessions parameters has been described with reference to unstructured PDU sessions, the present disclosure is not limited this and may be applied to any type of PDU sessions where valid PDU sessions parameters and operations are not common to all PDU sessions types regardless of the specific PDU sessions type that a parameter/operation is invalid for.

At step 102, the UE receives a PDU session management message, where this message may be a PDU sessions establishment request or a PDU session modification request. However, as set out above, the proposed technique is not limited to only these types of messages and is applicable to any type of message which establishes or modifies the parameters of a PDU session. For example, the UE may receive a NAS message, either in S1 mode or in N1 mode, where the NAS message is related to PDU session establishment procedure (e.g. ACTIVATE DEFAULT EPS BEARER CONTEXT REQUEST message in case of S1 mode, or PDU Session Establishment Accept message in case of N1 mode) or the NAS message is related to a PDU session modification procedure/EPS bearer activation or modification procedure (e.g. ACTIVATE DEDICATED EPS BEARER CONTEXT REQUEST message or MODIFY EPS BEARER CONTEXT REQUEST message in case of S1 mode, or PDU Session Modification Command message in case of N1 mode). When a PDU session management message has been received, the method proceeds to step 104.

At step 104, the UE determines, based on a type of the PDU session, whether the PDU session management message includes an operation related to an invalid PDU session parameter. This determination process may include any of the approaches to detecting erroneous/invalid PDU sessions parameters and operations set out above. For example, it may include detecting operations for the establishment of invalid PDU parameters of the modification of PDU parameters to invalid values for the type of PDU session which is being established or modified.

Whilst the step of 104 is shown to be separate to steps 108 and 110, it be performed either separately to or in conjunction with these steps. For example, step 104 may be formed on the received message prior to any implementation of the message parameters, be performed whilst the message parameters are being implemented, or take place once the message parameters have been implemented. The stage at which the determining takes place may be dependent on the type of PDU session management message.

At step 106, if the PDU session management messages relates to an invalid PDU session parameter or operation, the method proceeds to step 110. If the PDU session management messages does not relates to an invalid PDU session parameter or operation, method proceeds to step 108 and the implementation of the PDU session management messages is performed in a conventional manner.

At step 110, the UE proceeds with performing some form of rectification action, such as any of those previously described. Such rectification action may take the form of releasing, modifying or rejecting the PDU session. For example, when the PDU session management message is a request for establishment of a PDU sessions, the UE may transmit a PDU sessions release request or a PDU sessions modification request. If the PDU session management message is a modification request, the US may either request release or modification of the sessions, or reject the modification message. Alternatively, the UE may simply locally delete the invalid parameters or choose not to implement them.

Also at step 110, the UE may optionally transmit an error indication to the network indicating the type or specific error that has occurred, where the error may take the form of an established 5GSM cause code or a newly defined error or cause code.

If the UE sends a NAS message to the network based on a detected error that needs to be reported, the NAS message may be sent in S1 mode and hence may be an ESM message as defined in TS 24.301 [3] (e.g. the NAS message may be ACTIVATE DEFAULT EPS BEARER CONTEXT ACCEPT message or ACTIVATE DEDICATED EPS BEARER CONTEXT ACCEPT message) and the UE may include any of the existing cause codes.

FIG. 2 provides a schematic diagram of the structure of a terminal 200 which is arranged to operate in accordance with any of the examples of the present disclosure described above. The terminal may alternatively be referred to as UE, mobile terminal, device, mobile device or other equivalent term, and may represent, among other things, a smartphone, an MTC device, an IoT devices, and an IIoT device for example. The terminal 200 includes a transmitter 202 arranged to transmit signals to one or more base stations of a mobile communications network; a receiver 204 arranged to receive signals from one or more base stations of a mobile communications network; and a controller (same with processor) 206 arranged to control the transmitter and receiver and to perform processing in accordance with the above described methods. As well as transmitting signals to and receiving signals from base stations, the terminal may also communicate with relay nodes of a mobile communications network, another terminal of the mobile communications network, or a terminal or access point outside the mobile communications network

Although in FIG. 2 the transmitter, receiver, and controller have been illustrated as separate elements, any single element or plurality of elements which provide equivalent functionality may be used to implement the examples of the present disclosure described above. For example, the transmitter and receiver of the terminal 200 may be combined in the form of a transceiver.

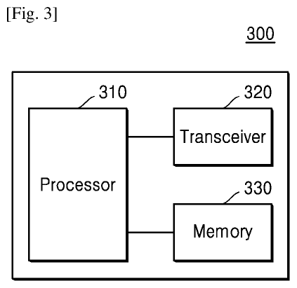

FIG. 3 illustrates a base station according to embodiments of the present disclosure.

Referring to the FIG. 3, the base station 300 may include a processor 310, a transceiver 320 and a memory 330. However, all of the illustrated components are not essential. The base station 300 may be implemented by more or less components than those illustrated in FIG. 3. In addition, the processor 310 and the transceiver 320 and the memory 330 may be implemented as a single chip according to another embodiment.

The aforementioned components will now be described in detail.

The processor 310 may include one or more processors or other processing devices that control the proposed function, process, and/or method. Operation of the base station 300 may be implemented by the processor 310.

The transceiver 320 may include a RF transmitter for up-converting and amplifying a transmitted signal, and a RF receiver for down-converting a frequency of a received signal. However, according to another embodiment, the transceiver 320 may be implemented by more or less components than those illustrated in components.

The transceiver 320 may be connected to the processor 310 and transmit and/or receive a signal. The signal may include control information and data. In addition, the transceiver 320 may receive the signal through a wireless channel and output the signal to the processor 310. The transceiver 320 may transmit a signal output from the processor 310 through the wireless channel.

The memory 330 may store the control information or the data included in a signal obtained by the base station 300. The memory 330 may be connected to the processor 310 and store at least one instruction or a protocol or a parameter for the proposed function, process, and/or method. The memory 330 may include read-only memory (ROM) and/or random access memory (RAM) and/or hard disk and/or CD-ROM and/or DVD and/or other storage devices.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The various embodiments of the present disclosure may also be implemented via computer executable instructions stored on a computer readable storage medium, such that when executed cause a computer to operate in accordance with any other the aforementioned embodiments.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in the accompanying claims.

1. A method for managing a Protocol Data Unit (PDU) session at a terminal in a mobile communications network, the method comprising:
receiving, from the mobile communications network, a PDU session management message associated with a PDU session;
determining, based on a type of the PDU session, whether the PDU session management message includes an operation related to an invalid PDU session parameter, and
in case that the PDU session management message includes the operation related to the invalid PDU session parameter, rejecting the PDU session management message, releasing the PDU session, or modifying the PDU session.

2. The method of claim 1, wherein the determining whether the PDU session management message includes an operation related to the invalid PDU session parameter includes:
determining whether the PDU management message is associated with an unstructured PDU session, and
determining whether the PDU management message includes an operation related to a PDU session parameter that is invalid for an unstructured PDU session.

3. The method of claim 2, wherein the determining whether the PDU session management message includes an operation related to the invalid PDU session parameter further includes determining whether the PDU session management message is an initial request or a request for modifying an existing PDU session.

4. The method of claim 2, wherein the operations related to the PDU session parameter that is invalid for an unstructured PDU session include at least one of:
a request for creating or modifying a non-default Quality of Service (QoS) rule;
a request for creating or modifying a QoS flow description that does not correspond to a default QoS rule of the PDU session;
a request for creating or modifying a mapped Evolved Packet System (EPS) bearer that does not correspond to a default QoS rule of the PDU session;
a request for creating a default QoS rule with a non-zero number of packet filters; or
a request for modifying a packet filter associated with a QoS rule.

5. The method of claims 4, wherein an empty packet filter list for the default QoS rule relates to a valid PDU session parameter for the unstructured PDU session.

6. The method of claim 1, wherein the modifying the PDU session includes deleting the invalid PDU session parameter resulting from the operation related to the invalid PDU session parameter.

7. The method of claim 1, wherein the modifying the PDU session includes transmitting to the mobile communications network a request for modifying the invalid PDU session parameter resulting from the operation related to the invalid PDU session parameter.

8. The method of claim 7, wherein the request for modifying the invalid PDU session parameter includes a request for deletion of the invalid PDU session parameter.

9. The method of claim 1, wherein releasing the PDU session includes transmitting to the mobile communications network a request for release of the PDU session.

10. The method of claim 1, wherein, in case that the type of the PDU session is an unstructured PDU session, a request for creating a default QoS rule with a zero number of packet filters relates to a valid PDU session parameter.

11. The method of claim 1, wherein the PDU management message is for establishing a new PDU session or a request for modifying an existing PDU session.

12. The method of claim 1, wherein, in case that the PDU session management message includes the operation related to the invalid PDU session parameter, the method further includes transmitting to the mobile communications network an indication or a cause value that the PDU session includes the invalid PDU session parameter.

13. The method of claim 1, wherein the PDU session management message is associated with an unstructured PDU session.

14. The method of claim 1, wherein the mobile communications network is a 3GPP 5G communications system.

15. A terminal for managing Protocol Data Unit (PDU) sessions in a mobile communications network, the terminal comprising
a transceiver, and
a controller and the controller coupled with the transceiver and configured to:
receive, from the mobile communications network, a PDU session management message associated with a PDU session;
determine, based on a type of the PDU session, whether the PDU session management message includes an operation related to an invalid PDU session parameter, and
in case that the PDU session management message includes the operation related to the invalid PDU session parameter, reject the PDU session management message, release the PDU session, or modify the PDU session.
